(19) United States
(12) Patent Application Publication
(10) Pub. No.: US 2017/0249257 A1
(43) Pub. Date: Aug. 31, 2017

(54) SOLID-STATE STORAGE DEVICE FLASH TRANSLATION LAYER

(71) Applicant: ITU Business Development A/S, Copenhagen S (DK)

(72) Inventors: Philippe Bonnet, Copenhagen S (DK); Niv Dayan, Copenhagen S (DK)

(21) Appl. No.: 15/056,381

(22) Filed: Feb. 29, 2016

(51) Int. Cl. G06F 12/12; G06F 12/02; G06F 12/08

(52) U.S. Cl. CPC G06F 12/121; G06F 12/0804; G06F 12/0246; G06F 12/0253; G06F 12/0891; G06F 2212/1044; G06F 2212/2022; G06F 2212/60; G06F 2212/7201; G06F 2212/7205

(57) ABSTRACT

Embodiments of the present invention include a method for storing a data page d on a solid-state storage device, wherein the solid-state storage device is configured to maintain a mapping table in a Log-Structure Merge (LSM) tree having a C₀ component which is a random access memory (RAM) device and a C₁ component which is a flash-based memory device. Methods comprise: writing the data page d at a physical storage page having physical storage page address P in the storage device in response to receiving a write request to store the data page d at a logical storage page having a logical storage page address L; caching a new mapping entry e(L,P) associating the logical storage page address L with the physical storage page address P; providing an update indication for the cached new mapping entry to indicate that the cached new mapping entry shall be inserted in the C₁ component; and evicting the new mapping entry from the cache. Corresponding solid-state storage device is also provided.

### BACKGROUND OF THE INVENTION

Flash memory has enabled a new generation of portable electronics due to its low power consumption, shock resistance and compactness. Unfortunately, flash devices have a limited lifetime that decreases as a function of writes. Moreover, small-grained updates cannot be made efficiently in the physical space. A so-called flash translation layer (FTL) is used to manage these characteristics by supporting out-of-place updates and wear-levelling. A crucial component for achieving these tasks is providing a mapping scheme from logical to physical addresses, as logical pages are continually migrated around the device. In state-of-the-art FTLs, this mapping table is stored in flash while frequently accessed mapping entries are cached in SRAM. Updating the flash-resident mapping as entries are evicted from the cache entails flash writes, which contribute to write amplification, a phenomena whereby the number of physical writes is greater than the number of logical writes.

Because of write amplification, current industry trends do not bode well for modern FTL designs. Since the cost of SRAM is decreasing at a slower rate than the cost of flash, an ever-lower fraction of the mapping table can be cached.

Secondly, as the density of flash devices is increasing, the latency of writes is increasing, and the device's lifetime and reliability as a function of writes is decreasing. Thus, as flash devices continue to scale in terms of density, write amplification under such FTLs will increase and its impact will become more destructive. The idiosyncrasies of flash memory combined with current industry trends are giving rise to new challenges in the management of flash devices.

### Log-Structured Merge FTL

### 1. Introduction

A flash storage device consists of several flash chips wired in parallel to a controller. Each chip contains thousands of flash blocks, and each flash block contains hundreds of flash pages. A flash page is the basic unit of storage comprising typically 4-16 KB. Read and write operations on modern flash devices are subject to the following restrictions: (1) they have the granularity of one flash page, (2) pages must be written sequentially within a block, (3) any update to a page must be preceded by an erase operation, (4) an erase operation has the granularity of a flash block, and (5) each block can only undergo a certain number of erases before becoming too error-prone to store data reliably. Finally, the latency for the different flash operations is highly asymmetric: page reads, writes and erases are in the order of tens, hundreds and thousands of microseconds respectively.

To manage these characteristics while exposing a simple block device interface to the application, flash devices employ a so-called flash translation layer (FTL). The FTL manages the erase-before-write constraint by performing out-of-place updates. In other words, when a logical page is updated, its new version is written on a different flash block with free physical space, while the previous version, the before-image, is marked as invalid. The FTL later reclaims invalid space occupied by before-images through garbage-collection operations, which migrate any remaining valid pages in the target block to a different block with free space and finally erase the target block. The FTL also performs wear-levelling to ensure that all blocks in the device age at an even rate. The page migrations issued due to garbage-collection and wear-levelling contribute to write amplification, a phenomenon whereby the number of physical writes that take place is a multiple of the number of logical writes.

To support out-of-place updates, garbage-collection and wear-leveling, the FTL must implement a mapping table from logical to physical addresses. A trivial way of implementing this mapping table is as a RAM-resident array, with one entry per logical page. Indeed, flash devices possess a moderate amount of SRAM for storing metadata. The issue is that the amount of SRAM available is insufficient for storing the entire mapping table. For instance, a 2 TB SSD would require approximately 1 GB in SRAM for storing the mapping table (this example assumes 4 bytes per mapping entry and 2²⁷ mapping entries). Since the cost of SRAM is currently approximately USD 5 per megabyte, providing this amount for consumer portable devices is infeasible.

Numerous RAM-efficient FTLs have been proposed over the past decade and are summarised in a recent survey [16]. The state-of-the-art design paradigm is to store a page-associative mapping in flash, while using a small LRU (Least Recently Used) cache in SRAM for storing frequently accessed mapping entries. The page-associativity of these FTLs mean they can support random updates more efficiently than in previous FTL design paradigms. Page-associative mapping means that there is a mapping entry for every logical page.

Unfortunately, current industry trends do not bode well for such FTL designs. The first problem is that SRAM is not scaling as fast as flash in terms of cost and density. Thus, an ever-lower fraction of the mapping table will fit into the SRAM cache. This will result in more pressure on the cache, and more flash writes will be needed to synchronize the cache's contents with the flash-resident mapping. We show that this could as much as double write amplification.

The second problematic industry trend is that as the density of flash devices is increasing, their reliability and longevity as a function of writes is decreasing, and the latency of write and erase operations is increasing. Thus, the impact of write amplification will become increasingly destructive.

### 2.1 Flash Devices and Industry Trends

Over the past decade, usage of flash memory has been increasing at an exponential rate. A driving force behind this trend are portable devices like digital cameras, MP3 players, USB drives and mobile phones, which occupy well over half the amount of flash memory on the planet [5]. Meanwhile, flash devices are continuing to advance in terms of cost and capacity. Sandisk has recently premired the world's first 512 GB SD card, selling for approximately USD 500. Flash SSDs offering terabytes are al-ready here, and flash devices offering terabytes for portable gadgets are on the horizon [6].

A flash device is managed by a micro-controller for running the FTL. The micro-controller typically includes tens of kilobytes of ROM and RAM to run the FTL program. An additional external RAM module may be provided for storing metadata.

The amount and type of external RAM module provided depends on the use-case for the flash device. DRAM is typically used for high-end SSDs, whereas SRAM is typically used for flash devices geared for portable devices. The reason is that on portable devices battery life is a stringent issue, and SRAM is a lot less power hungry than DRAM. Unfortunately, SRAM is also more expensive than DRAM and flash by two and three orders of magnitude respectively. A megabyte of SRAM today sells for approximately USD 5. 100 MB of SRAM would cost as much as Sandisk's aforementioned entire 512 GB SD card. This price and density gap is expected to widen in the future as flash is scaling much faster than SRAM.

As mentioned, a second problematic industry trend is that as the density of flash memory is increasing, the latency for write operations is increasing, and device longevity and reliability as a function of writes are decreasing [6]. The reason for this is twofold as flash is scaling in two distinct ways. The first is scaling in terms of feature size, which means shrinking the size of flash cells. As feature size increases, electrical interference among cells becomes increasingly common and results in lower reliability. The second way of scaling is in terms of bit density, which entails storing more than 1 bit per flash cell. Indeed, each cell can be thought of as containing a value that increases as we apply voltage to it. Using different ranges of this value, we can encode multiple bits in one cell. However, doing this requires controlling the cell's value with great precision, and the ability to program the cell precisely decreases as a function of erases. As a result of both scaling trends, writes must be made more carefully and precisely to maintain reliability. In practice, this is done by programming a cell with less voltage over a longer period of time. To make this concrete, the latency of a flash write relative to a flash read is greater by a factor of 10, 20 and 40 depending on whether the cell stores 1, 2 or 3 cells [6]. The increase in feature size is expected to further widen this cost gap. In light of these industry trends, our goal is to design an FTL for terabyte flash devices with an SRAM module comprising at most a few megabytes, while keeping in mind that the cost of a flash write is large and increasing relative to the cost of a flash read.

### 2.2 a Brief History of FTLs

A recent survey [18] gives a comprehensive overview of the evolution of FTLs over the past two decades. This evolution has mostly been in terms of finding cleverer ways to reduce write amplification while keeping the SRAM footprint and the translation lookup overheads low.

The vast majority of early FTL designs strive to keep the RAM footprint low by restricting the flexibility of the mapping scheme. Under these schemes, most blocks in the system, called data blocks, store contiguous strands of logical pages. A smaller number of so-called log blocks are used to support out-of-place updates to data blocks. Log blocks are eventually merged with data blocks. For data blocks, a block-associative mapping (i.e. one mapping entry per flash block) is used, where for the log blocks a page-associative mapping (i.e. one mapping entry per flash page) is used. Since most blocks in the system are data blocks, the overall amount of SRAM required for storing all the mapping information remains low.

Under NFTL [1, 20] and BAST [10], each log block can support out-of-place updates for one data block. Updates are written sequentially on a log block in the order they are updated. When the log block runs out of space, it is merged with the corresponding data block. The merge operation copies the most recent version of each logical page from the data block and log block on another free block. Ultimately, the free block turns into the new data block, and the original data block and log block are erased. Write amplification is typically 2 as a page update involves two physical writes, one on a log block and one during a merge operation. A serious problem with these schemes, however, is that contention for log blocks may occur if logical pages on many data blocks are updated at the same time. This may lead to thrashing, a phenomenon whereby we are forced to prematurely merge a log block before it has ran out of free space in order to clear space for an incoming updates from a different data block. This can increase write amplification to as much as B if log blocks are merged on average after undergoing only one update.

FAST [13] alleviates the issue of thrashing by making log blocks fully-associative. In other words, a log block can store updated pages from any data block. Thus, data blocks never need to contend for log blocks, and premature merge operations cannot occur. The problem is that the cost of a merge may be greater as it is likely to span multiple data blocks.

Variants of FAST, NFTL and BAST strive to restrict the associativity of log blocks to mitigate the risk of thrashing while controlling the maximal cost of a merge. For example, Superblock FTL [9] allocates M log blocks for every N contiguous logical data blocks. Other variants, including SAST, [24], KAST [3] and A-SAST [14], adaptively tune N and M to exploit different types of locality in the workload or to provide performance guarantees.

### 3.1 Flash-Resident Page-Associative FTLs

Starting with DFTL [7], a new family of FTLs emerged that is considered the state-of-the-art at minimizing write amplification while keeping the SRAM footprint low [18]. These FTLs are entirely page-associative and store the mapping table in flash. An SRAM-resident LRU cache is used to store frequently accessed mapping entries. Since these schemes are completely page-associative, they obviate merge operations and eliminate the risk of thrashing. Thus, write amplification is generally lower, especially under random updates. However, this family of FTLs introduces new costs. (1) When an application read arrives and corresponding mapping entry is not cached, the flash resident mapping must first be accessed. We call this a cache miss. (2) When a mapping entry has been updated, it must eventually be synchronized with the flash-based mapping. This is done through Synchronization operations, which contribute to write amplification.

In DFTL each translation page stores a fixed number of mapping entries that are contiguous in the logical address space. A global mapping directory (GMD) in SRAM keeps track of the whereabouts of all translation pages as well as which address range they contain. The cost of a cache miss is one flash read, and the cost of a synchronization operation is one flash read and one flash write. LazyFTL is a variant of DFTL that separates hot and cold data and provides better consistency guarantees to avoid losing cached addresses in the event of a power failure.

Under DFTL and LazyFTL, the flash-resident mapping is updated in a lazy fashion. When an application write takes place, a mapping entry for the logical page is first inserted into the cache with a dirty flag turned on to signify that it has not yet been synchronized with the flash-resident mapping. When a dirty entry is evicted from the cache, the appropriate translation page is read, updated and written back to flash. We refer to this as a synchronization operation. These FTLs also opportunistically exploit synchronization operations to scan the cache for any other dirty entries that belong to the translation page and update them on the translation page so as to avoid future synchronization operations.

In u-tree, the goal is to support multiple mapping granularities like Variable FTL [2], but while keeping the mapping table stored in flash. u-tree achieves this by indexing mapping entries in a B-tree variant for flash called u-tree [8]. A cache miss entails one index lookup, and lookup involves a logarithmic number of flash reads. A synchronization operation occurs immediately for each write, and it involves one lookup and one update to a page.

### 3.2 Garbage-Collection and Wear-Leveling

Under all page-associative flash-resident schemes, a garbage-collection module is necessary to free up physical space consumed by before-images. A garbage-collection operation involves (1) identifying a target blocks with relatively few remaining life pages, (2) migrating these live pages from the target block onto other blocks with free space, and (3) erasing the target block. The level of write amplification induced by garbage-collection migrations is studied in [25, 17, 4, 22]. Here, this is referred to as WA_{GC}. WA_{GC} tends to increase as updates become smaller and/or more random. Of all contributing factors to write amplification, WA_{GC} is typically the greatest.

A wear-levelling module is also needed to ensure that blocks age at a similar rate. The role of this module is to place hot data on relatively young blocks and cold data on relatively old blocks. Another role is to identify relatively young blocks with cold data on them and to garbage-collect. We refer to the contribution of wear-levelling to write amplification as WA_{WL}. The value of WA_{WL} depends on how much disparity between block ages we are willing to tolerate. Since the lifetime of flash devices is decreasing as an industry trend, WA_{WL} may be significant, especially when the skew in update frequency is considerable.

### 3.3 Garbage-Collection Bookkeeping

In order to perform garbage-collection, we must maintain a bookkeeping for which pages in the device are invalid. A simple way of doing so is by maintaining a bitmap in SRAM with one bit for every physical page in the device that keeps track of whether that page is valid or not. We call this the Page Validity Bitmap (PVB). The problem is that for terabyte flash devices, the PVB may be too large to fit into the available SRAM. For example, for the prototype device in table 1, the size of the PVB is 16 MB. Seeing as SRAM costs 5$ per megabyte, this is too expensive. A naive solution is to store the PVB in flash. However, this would dramatically increase write amplification. The reason is that for every data page update or migration, we would also need to update a bit in PVB as invalid. This would double the write amplification that arises due to application writes, garbage-collection and wear-leveling. We refer to the write amplification arising from updating the PVB as W_{APVB}.

Our scheme called Logarithmic Gecko [21] recently solved this problem. We refer to [21] for a detailed description of Logarithmic Gecko. The paper is titled “Garbage Collection Techniques for Flash-Resident Page-Mapping FTLs” and is authored by Niv Dayan and Philippe Bonnet. It is also identified as arXiv:1504.01666v1 and can be retrieved at arXiv.org under this identifier, which is unique for this paper. The paper is hereby incorporated into the present specification by reference.

Logarithmic Gecko stores the PVB in flash as an LSM tree. Since LSM trees are heavily write-optimized, updating the PVB for data blocks does not significantly increase write amplification. An LSM tree consists of a series of runs of exponentially increasing sizes in flash. In Logarithmic Gecko, each run is a sorted mapping from block ids to bitmaps that indicate which pages on the block are invalid. To identify which pages in a block are invalid for garbage-collection, we search for its id in all runs and apply the bitwise or operator to all the bitmaps we find.

Logarithmic Gecko has a simple interface to the rest of the FTL. Whenever a dirty page is evicted from the cache, it must be informed of the physical address of the logical page's previous version to mark it invalid in the PVB. Moreover, it needs to keep track of the logical pages that were last written on each physical block (this information is maintained in a flash-resident reverse map). It can then accept a block ID and return a PVB for that block with complete information about which pages in the block are valid. Any page-associative flash-resident FTL can use Logarithmic Gecko as long as it supports this interface.

### 3.4 Recovery from Power Failure

Fast recovery from power failure is an important requirement for any FTL. The goal of a recovery algorithm is to restore the SRAM-resident metadata so that normal operation can resume. Ideally, recovery time should take no longer than a few seconds.

Recently, [21] described a fast recovery algorithm that is compatible with any page-associative flash-resident scheme. To recap, the algorithm commences by scanning one out-of-band area for every block in the system to determine the types of all flash blocks (i.e. does the block contain data pages, translation pages, etc.). Based on this information, key SRAM data structures like the GMD are then reconstructed. Finally, the algorithm recreates mapping entries in the cache for any entries that were dirty when power failure occurs. This is done so that these entries could be synchronized with the flash-resident mapping when normal operation resumes. Checkpoints are taken every period of C data page updates to ensure that no mapping entry can remain dirty in the cache for longer than C writes. C is the number of mapping entries that fit into the SRAM, organized for instance as an LRU (least recently used) cache.

Recovery time using this algorithm is O(K+C) out-of-band (OOB) reads. However, when normal operation resumes there is an additional cost of O(C) OOB reads and O(C·W) flash writes, where W is the amortized cost of reporting a physical page as invalid to Logarithmic Gecko. Here, K is the number of blocks in the SSD.

### 3.5 LSM Trees

LSM-FTL relies on a classic data structure called a Log-Structured-Merge tree (LSM tree) [23]. An LSM tree comprises a logarithmic number of levels of exponentially increasing sizes. Each level typically stores 0 or 1 array, called a “run”, of index entries sorted by the index key. A tuning parameter T may define the size ratio between runs in two adjacent levels. A run at level i consists of between Tⁱ⁻¹ and Tⁱ−1 pages.

Updates are made into a RAM-resident buffer. When the buffer fills up, its contents are written as a run into level 1 of the tree. The buffer is then cleared so it can continue handling updates. There is an invariant that a level cannot contain more than two sorted runs. Thus, the next time the buffer is flushed and there are two runs in level 1, the two runs are merged. They may be merged using an algorithm identical to the second phase of the classic sort-merge join algorithm.

During a merge, a collision occurs the runs contain two entries with the same key. In this event, the entry from the most recent run is kept while the other is discarded. Thus, the resulting run may be smaller than the combined size of the runs being merged.

When the merge is finished, the two original runs are disposed of. The resulting run may be moved to the next higher level depending on its size. If it is moved and there are now two runs at the next level, another merge occurs. Thus, a merge may continue recursively.

The cost of a page update is an amortized O(T/B*log_{T} (Q)) reads and writes. The intuition is that each entry is rewritten O(T) times within each level, that it goes through O(log_{T} (Q)) levels, and that there are B entries per flash page, and so each IO rewrites B entries each time. Note that O(T/B*log_{T} (Q)) is typically must lower than 1. For this reason, LSM trees are considered heavily write-optimized. Q is the number of translation pages. In LSM-FTL, Q denotes the number of translation pages in the largest run.

FIG. 1 shows how increasing the device capacity relative to the cache size increases write amplification due to synchronization operations as well as read-amplification due to cache misses. The SRAM size is held constant at 1 MB, and we assume 8 bytes per mapping entry. A flash page is assumed to be 16 KB. A lookup typically probes each run in order from smallest to largest until the key being sought is found. In the classic LSM tree design, a binary search is used to search each run. Since a binary search costs O(log₂(Q)) and there are O(log_{T} (Q)) levels that need to be searched, the cost of a lookup is O(log₂(Q)·log_{T} (Q)) reads.

An LSM tree also supports range queries. To do this, two lookups can be issued simultaneously for the starting and ending keys of the range. On each run, all entries between those keys are reported back. Note that we may need to read multiple pages on each run.

T, the size ratio between two adjacent levels, increases, the cost of updates increases and the cost of lookups decreases. Thus, T should be tuned carefully to strike a balance between update and lookup costs.

### 4. Selected Problems

Total write amplification is the sum of many contributing factors. As we have already seen, three of these factors are WA_{GC} due to garbage-collection migrations, WA_{MAP} due to wear-leveling migrations, and WA_{PVB} due to updating the flash-resident Page Validity Bitmap. An additional factor is WA_{MAP}, which accounts for the cost of updating the flash-resident logical to physical mapping. Note that these terms all have the same units. Each is a ratio of between (1) the number of physical pages that are written on aver [symbol] age by that module in FTL to (2) each physical page that is updated directly by the application. Thus, these terms can be added up to give total write amplification with respect to each physical that is directly updated by the application.

WAₜₒₜₐₗ=1+WA_{GC}+WA_{WL}+WA_{MAP}+WA_{PVB}+ . . . (1)

Here, focus is on WA_{MAP}. In general, the magnitude of WAMAP is captured by equation 2. As shown, WA_{MAP} depends on a constant that we call the synchronization ratio and denote as Rsynch. Rsynch is the proportion of synchronization operations that occur on average per data page update or migration. To give WA_{MAP}, this constant is multiplied by (1+WA_{GC}+WA_{WL}), which is the number of physical data pages that are updated or migrated on average per logical write.

WA_{MAP}=R_{synch}·(1+WA_{GC}+WA_{WL}) (2)

The magnitude of R_{synch} is determined by the FTL design. For example, in u-FTL, is 1, since a synchronization operation takes place immediately after a data page update or migration. This is quite high, especially since it effectively doubles the contributions of garbage-collection and wear-leveling to total write amplification.

Under DFTL, the value of R_{synch}, depends on the size of the cache relative to the size of the device. The reason is that DFTL performs synchronization operations lazily, and that each synchronization operation can clean multiple entries, as described in Section 3.1. Here is an analysis of R_{synch} under DFTL, by reasoning about the number of dirty entries that are cleaned on average per each synchronization operation. For now, it is assumed that 0the workload consists of uniformly randomly distributed updates.

Again, suppose that Q is the number of translation pages and C is the number of mapping entries that fit into the cache. Under uniform updates, there are on average C/Q entries in the cache associated with each translation page. Thus, each synchronisation operation results in the eviction of one mapping entry as well as the cleaning of on average C/Q entries. In other words, one synchronization operation oc [symbol] curs for every 1+C/Q page updates. R_{synch} is simply the inverse of 1+C/Q:

R_{synch}=Q/(C+Q) (3)

FIG. 1 illustrates R_{synch} for the prototype device in Table 1 of FIG. 2 as the flash device size (which increases Q) is increased while holding the cache size C constant.

When the device size is small relative to the cache size, R_{synch} is near zero. Indeed, in this case the cache can buffer many dirty entries, and so each synchronization operation manages to clean a lot of dirty entries thereby obviating future synchronization operations. When the device size relative to the cache size is large, R_{synch} is approximately 1, because most synchronization operations clean only the evicted entry on average. The point of inflection occurs when C=Q, at which point R_{synch}=0.5, since each synchronization operation on average evicts 1 entry and cleans 1 entry.

Today, the capacity of flash devices is in the order of hundreds of GB. As the graph in FIG. 1 indicates, we have reached the point where R_{synch} is increasing significantly every time we double the device size.

The rate in which R_{synch} is increasing is in fact even faster than described by the figure. The reason is that some essential SRAM-resident metadata used by the FTL will continue to grow in proportion to the device's capacity. For example, any FTL typically stores the ages of all blocks in the device in an SRAM-resident array for the purpose of wear leveling. The size of this array under the prototype device is 512 KB, it increases in proportion to the device size. The amount of SRAM consumed by such data structures becomes unavailable for caching. Thus, the assumption behind FIG. 1, namely that the cache size remains fixed as the device size increases, is optimistic. In reality, as other SRAM-resident structures grow, the size of the cache will shrink.

Let us now consider a hypothetical FTL, called Naive-FTL, which stores mapping entries in flash in the order they are written: a synchronization operation flushes the most recently written M mapping entries on one translation page. R_{synch} is therefore O(1/M). A cache miss, on the other hand, has the efficiency of O(Q) as it must scan all translation pages in a reverse order until it finds the key. As shown by FIG. 1, R_{synch} is extremely low under Naive-FTL, but cache misses are extremely expensive compared to the other FTLs.

### SUMMARY OF THE INVENTION

To alleviate or mitigate at least some of the issues described above, or as an alternative to existing technology, the present invention provides an FTL that indexes mapping entries in flash in a log-structured merge tree (LSM tree). In LSM-FTL, as the technology may be referred to, write amplification is very low and independent of the SRAM size. More reads are needed to access the mapping table, but this is a legitimate trade-off as the cost of reads relative to writes is low and decreasing. LSM-FTL can as much as double the device's lifetime and throughput under write-dominant workloads. Below, design and analysis of LSM-FTL is described in detail.

A first aspect of the invention provides a method for storing a data page d on a solid-state storage device. According to the invention, the solid-state storage device is configured to maintain a mapping table in a Log-Structure Merge (LSM) tree having a C₀ component which is a random access memory (RAM) device and a C₁ component which is a flash-based memory device. The mapping table comprises mapping entries between physical storage pages in the storage device and logical storage page addresses, whereby a physical storage page can be addressed using a corresponding logical storage page address. The method comprises:
writing the data page d at a physical storage page having physical storage page address P in the storage device in response to receiving a write request to store the data page d at a logical storage page having a logical storage page address L,
caching, in a cache in the C₀ component, a new mapping entry e(L,P) associating the logical storage page address L with the physical storage page address P, whereby the data page d can be addressed using the logical storage page address L and using the new mapping entry stored in the C₀ component,
providing an update indication for the cached new mapping entry to indicate that the cached new mapping entry shall be inserted in the C₁ component, and
evicting the new mapping entry from the cache.

In some embodiments, the evicting comprises:
determining if the update indication for the cached new mapping entry remains provided, and in the affirmative:
i) inserting the new mapping entry into the C₀ component.

Some embodiments further comprise:
providing a synchronization indication associated with the new mapping entry, the synchronization indication indicating whether an existing mapping entry in the C₀ component having logical storage page address L, if present in the C₀ component, belongs to a physical storage page that has not been reported to a garbage collection module in the storage device, and in the affirmative reporting said existing mapping entry to the garbage collection module, whereby said existing mapping entry is invalidated.

In some embodiments, inserting the new mapping entry into the LSM tree C₀ component comprises:
inserting the new mapping entry into an LSM tree buffer comprised in a random access memory unit in the storage device, and at a subsequent time flushing the buffer to the LSM tree C₀ component.

Some embodiments further comprise:
determining whether the LSM tree buffer comprises an already buffered mapping entry which is different from the new mapping entry and which has logical storage page address L, and in the affirmative to erase said already buffered mapping entry from the LSM tree buffer.

Some embodiments further comprise:
determining whether the LSM tree buffer requires flushing, and in the affirmative to flush the LSM tree buffer to the C₁ component.

A second aspect of the invention is a solid-state storage device. Embodiments of the solid-state storage device in accordance with the second aspect comprise a digital storage device controller that is configured to perform a method in accordance with an embodiment of the first aspect of the invention.

A third aspect is a method for looking up a physical storage page address associated with a logical storage page address L in a solid-state storage device in accordance with an embodiment of the second aspect. Embodiments of the method comprises:
determining whether the C₀ component comprises an already cached mapping entry having a logical storage page address L,
and if the C₀ component comprises an already cached mapping entry having logical storage page address L, then:
(1) returning a physical storage page address P of the already cached mapping entry, whereby the lookup has been effectuated,
whereas if the C₀ component does not comprise a cache mapping entry having a logical storage page address L, then:
   (a) retrieving an existing mapping entry by performing a search in the LSM tree for an LSM tree mapping entry having logical storage page address L,
   (b) inserting the retrieved mapping entry into the cache, and
   (c) returning the physical storage page address P of the retrieved mapping entry, whereby the lookup has been effectuated.

In some embodiments, for the case when the C₀ component does not comprise a cache mapping entry having a logical storage page address L, the method further comprises:
(i) providing an update indication for the retrieved mapping entry to indicate that the retrieved mapping entry shall not be inserted in the LSM tree C₁ component at a subsequent time, and
(ii) providing an indication that the retrieved mapping entry belongs to a valid storage page.

Some embodiments further comprise:
determining if the cache is full, and in the affirmative evicting another mapping entry from the cache, said another mapping entry being different from the retrieved mapping entry.

Some embodiments further comprise:
determining whether a synchronization indication associated with said another mapping entry indicates that an existing mapping entry in the LSM tree C₀ component has logical storage page address L and belongs to a storage page that has not been reported to a garbage collection module in the storage device, and in the affirmative reporting said existing mapping entry to the garbage collection module, whereby said existing mapping entry is invalidated, and
determining if the update indication for said another mapping entry remains provided, and in the affirmative:
i) inserting said another mapping entry into the LSM tree C₀ component.
2. A method in accordance with claim 11, wherein inserting said another mapping entry into the LSM tree C₀ component comprises:
   inserting said another mapping entry into an LSM tree buffer, and subsequently flushing the buffer to the LSM tree C₀ component.

Some embodiments further comprise:
determining if the LSM tree buffer comprises an already buffered mapping entry different from said another mapping entry and having logical storage page address L, and in the affirmative to erase said already buffered mapping entry from the buffer.

Some embodiments further comprise:
determining whether the LSM tree buffer is full, and in the affirmative flush the buffer to the C₁ component.

The invention further provides a solid-state storage device in accordance with the second aspect of the invention, further configured to perform a method in accordance with an embodiment of the third aspect of the invention.

Further methods are described in the detailed description.

### BRIEF DESCRIPTION OF THE DRAWINGS

FIG. 1 shows how increasing the device capacity relative to the cache size increases write amplification due to synchronization operations as well as read-amplification due to cache misses.

FIG. 2 shows specifications for a prototype storage device.

FIG. 3 shows a comparison of overheads for different garbage-collection techniques.

FIG. 4 illustrates an embodiment of a Write process in accordance with the invention.

FIG. 5 illustrates an embodiment of an Evict process in accordance with the invention.

FIG. 6 illustrates an embodiment of a Lookup process in accordance with the invention.

FIG. 7 illustrates an embodiment of an LSM tree search process in accordance with the invention.

FIG. 8 illustrates an embodiment of a Synchronize process in accordance with the invention.

FIG. 9 shows a comparison of overheads for lookups and data page updates under different FTLs.

FIG. 10 shows the relationship between T and R_{synch} for LSM-FTL for different flash device capacities

FIG. 11 illustrates a storage device in accordance with an embodiment of the invention.

FIG. 12 illustrates an embodiment of a Batch Synchronize process in accordance with the invention.

### DETAILED DESCRIPTION OF SELECTED EMBODIMENTS

In the following, embodiments of the invention are described. They are referred to under the name “LSM-FTL”.

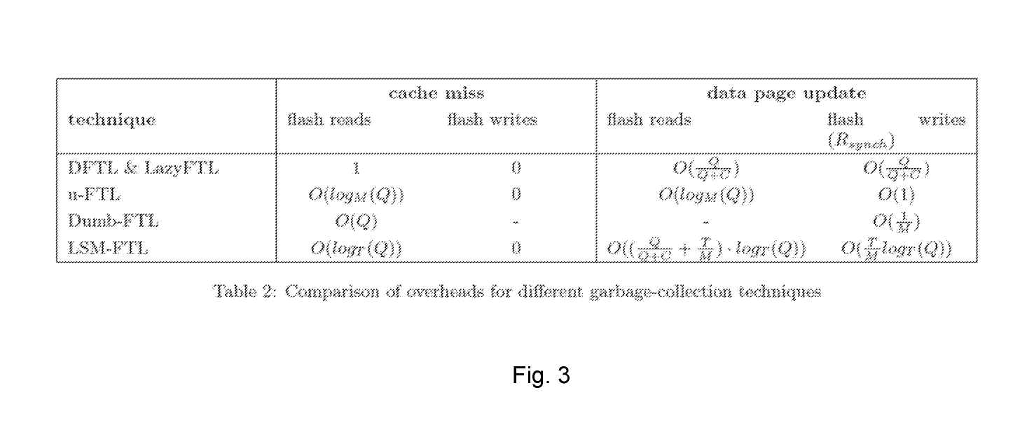

R_{synch} under LSM-FTL is nearly as low as for Naive-FTL, whereas the cost of cache misses is competitive with that of DFTL and u-FTL. A comparison of the costs of the different operations is given in Table 2 of FIG. 3.

LSM-FTL is a page-associative flash-resident FTL that indexes mapping entries using a LSM tree in flash memory. Since LSM trees are heavily write-optimized, the value of R_{synch} under LSM-FTL is extremely low. In fact, the design of LSM-FTL makes R_{synch} independent of the cache size. Thus, write amplification under LSM-FTL is significantly lower than under other FTLs, especially when the cache size is very small relative to the device size. The trade-off is that a lookup may involve several flash reads. However, we argue that under typical workloads, LSM-FTL would still lead to a net improvement in throughput relative to other FTLs due to a reduction in write amplification.

In some embodiments, LSM-FTL uses Logarithmic Gecko [21], described later in this specification, as its garbage-collection module, and it employs an adaptation of the fast recovery algorithm from [21].

LSM-FTL may store the flash pages that comprise the LSM tree on a separate set of blocks called translation blocks, whereas user data is stored in data blocks. In SRAM, LSM-FTL employs a data structure called the Global Mapping Directory (GMD), which keeps track of the state of the tree (i.e. the location, size and state of each run).

Section 5.1 describes how mapping entries are updated and inserted into the cache. When updated entries are evicted from the cache, they are inserted into the LSM tree's buffer. This buffer is eventually flushed to flash, at which point a merge operation may be triggered, as described in Section 5.2. Lookups into the LSM tree are described in Sections 5.3 and 5.4. In Section 5.5, we describe how synchronization operations are used to report invalid pages to the garbage-collection module.

In Sections 5.6 and 5.7, we describe embodiments of a garbage-collection policy for LSM-FTL and a recovery algorithm respectively. An optimisation that involves merging multiple runs at the same time is described in Section 5.8.

### 5.1 Updates

There are two blocks in the device called the active data block and active translation block. Updated data pages are written on the active data block, whereas new runs belonging to the LSM tree are written on the active translation block. When either runs out of free space, a new active block is requested from the free blocks pool.

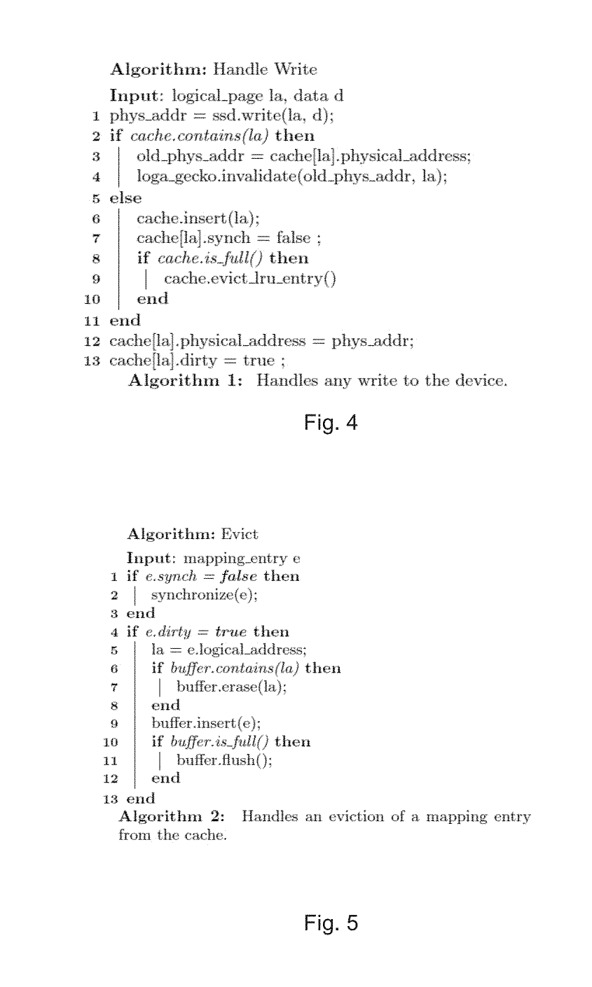

A logical page is updated using Algorithm 1 in FIG. 4. As an overview, the page's new version is first written onto the active data block. A mapping entry e=(L, P) from the logical page L to its new physical location P is then created and inserted to the cache. This cached entry has an associated dirty flag. It is set to true to indicate that the cached entry should be updated to the LSM tree when it is evicted from cache.

A cached mapping entry has one additional flag called the synchronization flag (“synch flag” for short). It indicates whether there is some mapping entry in the LSM tree with key L yet with a physical address of a before-image that has still not been reported to the garbage-collection module as invalid. If an entry's synchronization flag is set to true, we call the entry an unsynchronized entry. This flag is used to enable batch synchronization operations, as we will see in Section 5.5.1.

When a dirty entry e_{A} is inserted into the cache, its synch flag is set to true (line 7). However, if there is already an entry e_{B} with the same logical address in the cache, then entry e_{A} inherits the synch flag from entry e_{B}, and the physical address of entry e_{B} is reported to the garbage-collection module as invalid (line 4).

### 5.2 Evict, Flush and Merge

The routine for handing the eviction of an entry from the cache is listed in Algorithm 2 in FIG. 5. If the entry is unsynchronized, a synchronization operation for it is invoked, as described in Section 5.5. If it is still dirty after the synchronization operation, it is inserted into the LSM tree's buffer. If the buffer already contains a mapping entry with logical address, we replace it with the new one.

When the LSM tree's buffer fills up, it is written on the active translation block as a run at level 1 of the LSM tree. As described in Section 3.5, whenever there are more than one run in a level, they are merged, and the resulting run may be promoted to the next level of the tree based on its size. During a merge, we resolve any collision by discarding the entry from the older run.

Recall that R_{synch} is the number of flash writes needed on average to update 1 dirty entry into the flash-based mapping. In LSM-FTL, R_{synch} is simply equal the cost of inserting an entry into an LSM tree. Based on the analysis in Section 3.5, in our cases this cost is O(T/M*log_{T} (Q)). Note that since M, the number of mapping entries that fit into a translation page, is typically in the order of a few thousands, R_{synch} is extremely low under LSM-FTL.

### 5.3 Lookups

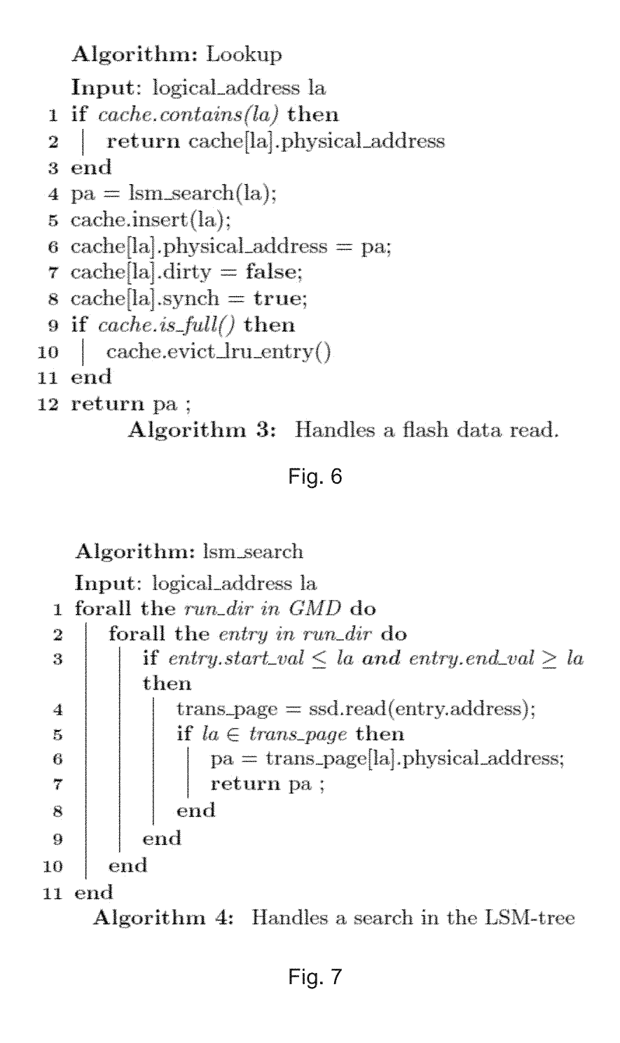

When an application read is made to logical page, we need to find the physical page that stores the most recent version of this logical page. This is handled using Algorithm 3 in FIG. 6.

We first check if the mapping address for the logical page is cached (line 1). If so, the physical address of the mapping entry is returned and the procedure terminates (line 2). A cache miss occurs if the corresponding mapping entry is not cached. In this event, we must look it up in the LSM tree, as described in the next section. When the mapping entry is found, we insert it into the cache with the dirty and synch flags are set to false and true respectively.

### 5.4 LSM Tree Search

A lookup in an LSM tree involves probing each run from the most recent to the least recent until the key is found. As we saw in section 3.5, the cost of a lookup under a classic LSM tree would be O(log₂(Q)·log_{T} (Q)) flash reads because there are O(log_{T} (Q)) runs and the cost of an external binary search is O(log₂(Q)) flash reads. In reality, this would lead to a cost of tens of flash reads per cache miss, which may take up to several milliseconds to complete. A goal is to keep the latency for reads in the order of hundreds of microseconds. To do so, we use two optimisations.

The first optimisation is an SRAM-resident partial index for each run called the run directory (RD). The RD is a mapping from the first key in each translation page to the physical location of that translation page. The run directory allows us to avoid having to do an external binary search for each run during a lookup. Instead, we can scan the RD for each run to narrow down on the only flash page in that run that can contain the key we are looking for. This takes away a factor of log₂(Q) thereby reducing lookup cost to O(log_{T} (Q)), as we now have to do at most 1 flash read per run. The search procedure using the run directories is listed in Algorithm 4 in FIG. 7.

The RD for a run can be built while the run is being created (during a merge operation). For the 2 TB prototype device in Table 1, the size of the RD for the largest run is at most 512 KB. The RDs for the remaining runs are exponentially smaller than the RD for the largest run, so they do not significantly further increase RAM-consumption.

A second optimisation we use to speed up lookups is parallelism. Recall that a flash device may consist of several chips wired in parallel, where each chip contains dies on which flash operations can be executed in parallel. If the translation pages we need to read during a lookup are on different dies, we can read them in parallel. Although a lookup still involves O(log_{T} (Q)) flash reads, we may be able to finish it in O(1) if all the reads occur in parallel. Note that the usage of parallelism is expressed in Algorithm 4 in FIG. 7.

### 5.5 Synchronization Operations

When an unsynchronized mapping entry is evicted from the cache, we must ensure that all of its physical before-images have been reported as invalid to Logarithmic Gecko in order to comply with Logarithmic Gecko's interface. Meeting this requirement in the context of LSM-FTL is a challenge for two reasons. Firstly, a cached unsynchronized entry may have multiple invalid entries on different runs of the tree. All of them must eventually be reported to Logarithmic Gecko. However, the same invalid entry should not be reported more than once. Logarithmic Gecko would still work if this happened, but its performance guarantee with regards to write amplification would no longer hold, as it would cause the write amplification induced by Logarithmic Gecko to increase by a factor of log_{T} (Q).

Secondly, we must ensure that merge operations in the LSM tree never discard (as a result of a collision) an invalid entry that has still not been reported to Logarithmic Gecko as invalid. Losing an unreported invalid entry e_{B}=(L_{B}, P_{B}) would make it very difficult to later detect that the physical page P_{B} is now invalid.

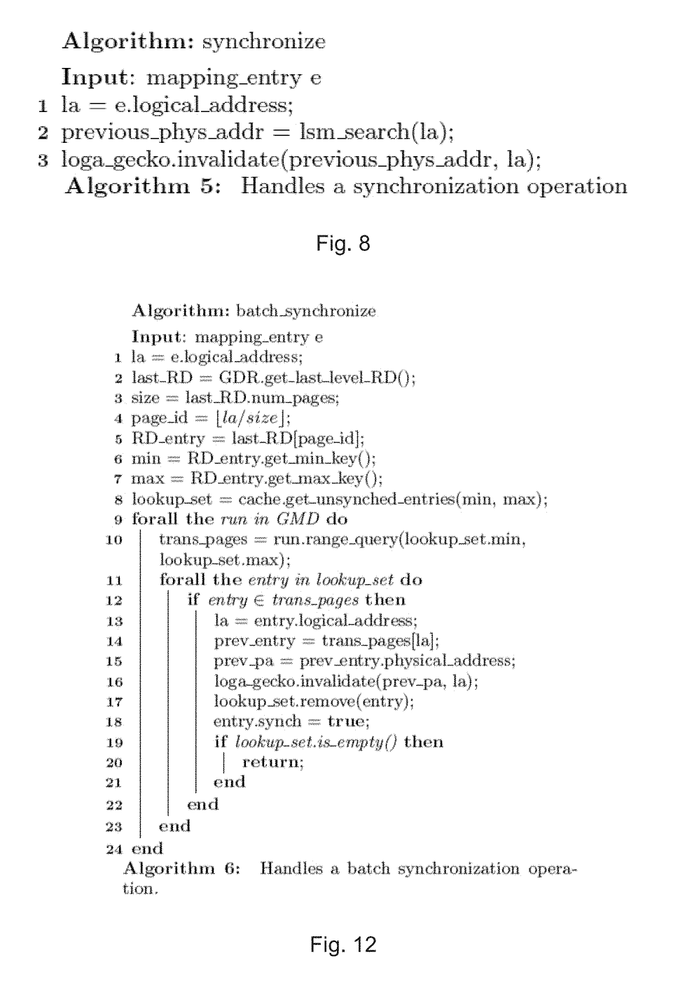

We meet these challenges with the following policy. When an unsynchronized entry e_{A}=(L, P) is evicted, we look up key L in the LSM tree. We report to Logarithmic Gecko the physical address of the first matching mapping entry we find. We call this a synchronization operation, and we detail it in Algorithm 5 in FIG. 8.

Note that under special circumstances introduced by the recovery mechanism in Section 5.7, the physical address of the first matching mapping entry may be the same as P. If this is the case, the two mapping entries are identical. The evicted entry is therefore marked as clean (line 7), so that it is not inserted into the LSM tree's buffer in Algorithm 2 in FIG. 5.

This policy implicitly assumes two things. (1) A cached unsynchronized entry e_{A} can have at most one unreported invalid entry e_{B}, and (2) this unreported invalid entry e_{B} must be the most recently inserted entry with key L in the tree.

Let us prove that these two assumptions hold given our policy. Consider all invalid mapping entries in the LSM tree with key L. Suppose that eₓ was most recently inserted, eₓ₋₁ was second most recently inserted, etc. When entry eᵢ was inserted to the tree, a synchronization operation took place that reported the physical address of entry eᵢ₋₁ to the GC module as invalid. Thus, only the most recently inserted entry eₓ to the tree can have a physical address that has still not been reported to the GC module as invalid.

A consequence of these assumptions is that an unreported invalid entry can never be discarded due to a collision during a merge operation. The reason is that a collision only discards the less recent entry, whereas an unreported invalid entry is necessarily the most recent entry in the tree with that given key.

With regards to impact on performance, note that a synchronization operation does not involve any flash writes, so it does not contribute to write amplification. However, it adds a cost of O(log_{T} (Q)) flash reads to any update or migration of a data page. We show how to reduce this cost in Section 5.5.1.

### 5.5.1 Batch Synchronization Operations

Suppose we evict an unsynchronized entry e_{A}=(L, P) from the cache. The goal of a batch synchronization operation is to identify other cached unsynchronized entries with keys that are close enough to L that the mapping entries for these entries would most likely be on the same translation pages as L in the LSM tree. Thus, several entries can be synchronized at the cost of one lookup. Batch synchronization is shown in FIG. 12.

We first establish the logical range of cached entries that can be included in the operation while keeping the cost of the operation O(log_{T} (Q)) flash reads (lines 1-7). We call it the inclusion range, and we simply set it to the range of keys in the └L/Q┘^{th} translation page in the largest run (this is the only translation page in the largest run that includes key L in its key range). By so doing, we also restrict the size of the inclusion range to M, the number of entries in one translation page. This gives a guarantee that number of translation pages that the inclusion range spans in each run of the tree is at most 2. Thus, we must read at most 2 translation pages for each run during the synchronization operation, and so we maintain a cost of O(log_{T} (Q)) for the operation.

We now search the cache for any unsynchronized entries in the inclusion range (line 8). We refer to these entries as being in a lookup set, and we refer to their logical range as the lookup range. Note that the lookup range is typically smaller than the inclusion range.

The next step is to make a range query in the tree for the lookup range. When we encounter the first matching entry e1 for any entry e2 in the lookup set, we follow these steps. (1) If the physical addresses of the entries are different, we report the physical address of e₁ as invalid to Logarithmic Gecko. Otherwise, the entries are identical and there is not need to insert e₂ into the tree. We therefore mark e₂ as clean. (2) We then remove e₂ from the lookup set, and (3) set the synch flag of e₂ to true. The synchronization operation is finished when the lookup set is empty.

Entries that were opportunistically included in the lookup set remain in the cache with the synch flag set to true. When these entries are later evicted from the cache, they will be inserted into the LSM tree's buffer without a synchronization operation.

The next question is by how much batched synchronization operations improve throughput relative to non-batched synchronization operations. The analysis needed to answer this question is identical to our analysis in Section 4 above for the number of entries that are cleaned in each synchronization operation in DFTL.

To recapitulate, if we assume uniformly randomly distributed updates, then we can expect each batch synchronization operation to include 1+C/Q unsynchronized entries. This means that the fraction of synchronization operations that occur in relation to page updates or migrations is the inverse: Q/(Q+C). This is an upper bound. Thus, the cost of a synchronization operation is O(Q/(Q+C)*log_{T} (Q)) per any update or migration of a data page.

Now, recall that the cost of an update or migration of a data page in terms of flash reads due to merge operations in the LSM tree is O(T/M*log_{T} (Q)). Thus, the total cost in terms of flash reads of an update or migration of a data page is:

$$O ( ( \frac{Q}{Q + C} + \frac{T}{M} ) {log}_{T} ( Q ) )$$

### 5.6 Garbage-Collection

Logarithmic Gecko maintains an array in RAM that keeps track of the number of identified invalid pages in all blocks and uses it for victim-selection. When the number of free blocks in the system drops below a threshold, such as 2, a victim data block with as many identified invalid pages as possible is selected as a victim and garbage-collected. Logarithmic Gecko's total SRAM consumption is acceptable for terabyte devices. Technical details are given in [21]. Since LSM-FTL is page-associative, it is compatible with more sophisticated schemes that optimise WA_{GC} by separating flash pages on different blocks based on their update frequencies and allocating relatively more over-provisioned space to the hotter groups [25, 22, 4]. Its page-associativity also makes LSM-FTL fully compatible with existing wear-leveling techniques, both dynamic and static [21].

The next question is how to garbage-collect translation blocks. Our answer is that they should not be directly garbage-collected at all, or at least not until all pages in a translation block become invalid and then erase the block. There are two reasons for this. Firstly, translation blocks constitute such a minuscule fraction of all blocks that we do not stand to reclaim much free space by garbage-collecting them. Secondly, the merge operations of the LSM tree provide a natural garbage-collection mechanism. As long as application writes continue to take place, any translation page is guaranteed to eventually participate in a merge operation and become invalid. Thus, all pages in any translation block will eventually be invalidated.

### 5.7 Recovery from Power Failure

To enable quick recovery from power failure, we use the algorithm from [21] that was described in Section 3.4. To make it compatible with LSM-FTL, we make three adaptations.

Adaptation 1: Firstly, we need a method to recover the run directories and the GMD. The challenge here is inferring which runs in the translation blocks are still valid and which are obsolete. Our approach is to add some metadata to every run. When a run is created, we give it a new unique ID. The first flash page of each run starts with a preamble that contains the runs level, its ID and the IDs of the runs that were merged to create it. The last page of a run ends with a postamble, which contains a copy of the run directory for the run. Every other page in a flash run begins with the id of the run that it belongs to. Note that we do not increase the number of pages in a run to support these additional metadata items. For example, for a run at level one that consists of one flash page, the preamble and postamble are both stored on that page.

With this additional metadata, we can recover the run directories and GMD during step 2 of the recovery algorithm. We discard any run without a postamble as it is only partially written. We also identify runs that have been made obsolete and discard them. We then recover to SRAM the run directories from the postambles of all the valid runs.

Adaptation 2: There is a special case under which we may lose access to live user data after recovery. To see this, suppose that an unsynchronized mapping entry e_{cache} is inserted into the cache. C more page updates to distinct logical pages take place until e_{cache} reaches the end of the LRU queue and is evicted from the cache. e_{cache} then participates in a synchronization operation and inserted into the LSM tree's buffer. At this point, power failure takes place. e_{cache} was not actually written to flash.

Although the recovery algorithm recreates mapping entries for the most recently written C distinct data pages (as described in Section 3.4), the problem is that than C entries had taken place since e_{cache} was first inserted into the cache. Thus, the entry for e_{cache} is lost, and we can no longer access the updated data page that it points to.

We have a mechanism in place that can be adapted to fix this problem. Recall from section 3.4 that checkpoints are periodically taken during the SSD's normal operation. These checkpoints guarantee that any mapping entry that has been in the cache for longer than C data page updates is cleaned. Our solution is to simply reduce the checkpoint period to C−M, where M is the size of the size Thus, any mapping entry that was in the LSM tree's buffer when power failure occurred would get recovered into the cache.

Adaptation 3: When power failure occurs, we lose the contents of Logarithmic Gecko's LSM tree's buffer. This buffer contains information about physical pages that have recently become invalid. This information must be recovered so that Logarithmic Gecko can keep track of which pages are invalid. This problem was solved in [21] in the context of DFTL. The solution in LSM-FTL is similar.

We will illustrate the problem with an example. Consider a mapping entry e₁=(X, V₁) on some run Y of the LSM-FTL's LSM tree. An update to logical address X then takes place and a dirty entry e₂=(X, V₂) is created for it in the cache. At some point, entry e₂ is evicted from the cache and. A synchronization operation takes place and reports the physical address V₁ as invalid to Logarithmic Gecko. V₁ is inserted into the buffer of Logarithmic Gecko's LSM tree, and entry e₂ is inserted into the buffer of LSM-FTL's LSM tree. LSM-FTL's buffer then flushes and its contents turn into a run Z at level 1 of LSM-FTL's LSM tree. A recursive merge operation now takes place that includes runs Z and Y. During this merge, a collision takes place between entries e₁ and e₂. Since e₁ is the older entry, it is discarded. The block on which run Y was written is then erased. At this point, a power failure takes place. Thus, we lose the contents of Logarithmic Gecko's buffer thereby losing track of the fact that physical page V₁ is now invalid. We solve this problem by ensuring that the now invalid run Y does not get erased until the LSM tree's buffer is flushed. We do so by maintaining a list of runs in SRAM whose underlying blocks cannot be erased until the next time the LSM tree's buffer is flushed, and we insert Y into this list. We call it the pinned runs list. Since there are log_{T} (Q) runs, the size of this list remains small.

We now need to extend the recovery algorithm to detect the lost invalid physical address V₁ and reinsert it into the LSM tree's buffer. Our approach is to first find the times-tamp from the postamble of the least recently created run of the gecko-tree. We then recover the pinned runs list by finding all runs that became invalid after this timestamp. Thus, we find runs Z and Y. We perform an intersection operation on them to detect collisions. Thus, we detect that a collision had previously taken place between entries e₁ and e₂, and that physical page V₁ is now invalid, so we reinsert V₁ to Logarithmic Gecko's buffer.

### 5.8 Multi-Way Merging

In Section 3.5, we saw that a merge operation may continue recursively, as long as the result of the merge is promoted to the next level and there is already a run at the next level. Recursive merges are in fact wasteful in terms of IOs, because the same elements from lower runs are rewritten several times. We can reduce the number of IOs by detecting in advance if the merge is likely to be recursive, and if so making a multi-way merge instead. A multi-way merge spans several runs at the same time. The run at level i participates in a merge is if: (1) it is not already participating in another merge, (2) there is at least one run at level i−1 participating in this merge, and (3) all the runs at level i−1 which are participating in the merge have a combined size of at least s=(T¹−Tⁱ⁻¹). A disadvantage of this is that more input buffers are needed in RAM to perform the multi-way merge. If W is the number of runs participating in the merge, then we need W input buffers and 1 output buffer.

### 6. Tuning and Analysis

The parameter T is the size ratio between two adjacent levels in an LSM tree. It controls a trade-off between the cost of lookups and the amortized cost of updates. Since the number of trees is L=O(log_{T} (Q)), increasing T reduces L thereby decreasing the number of flash reads that are needed per lookup. On the other hand, the amortized cost of an update is R_{synch}=O(T/M*log_{T} (Q)), which increases as T increases. The challenge, then, is striking a good balance between the cost of lookups and the cost of insertions.

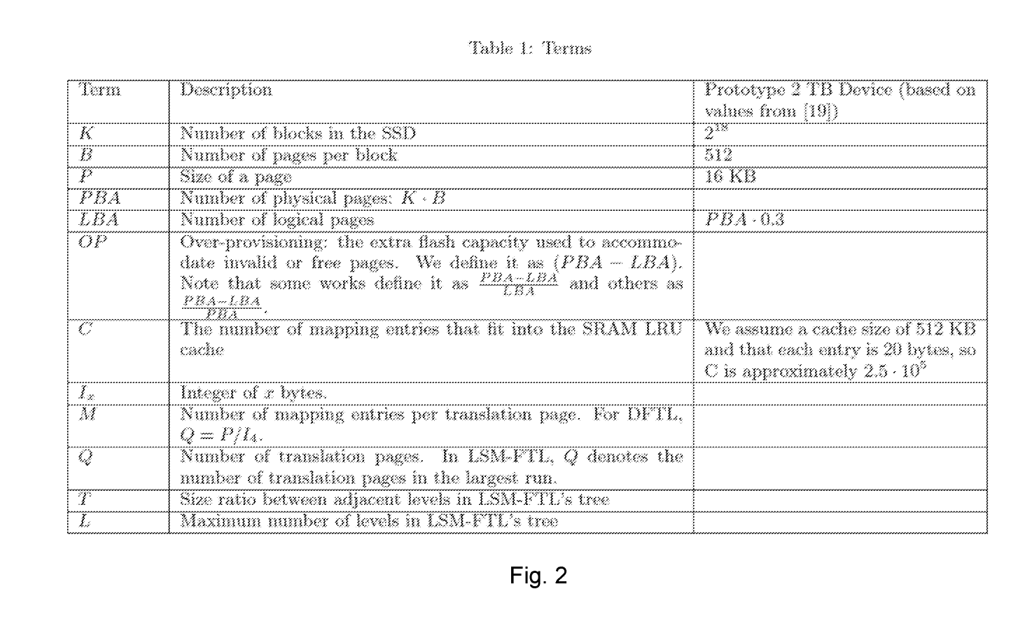

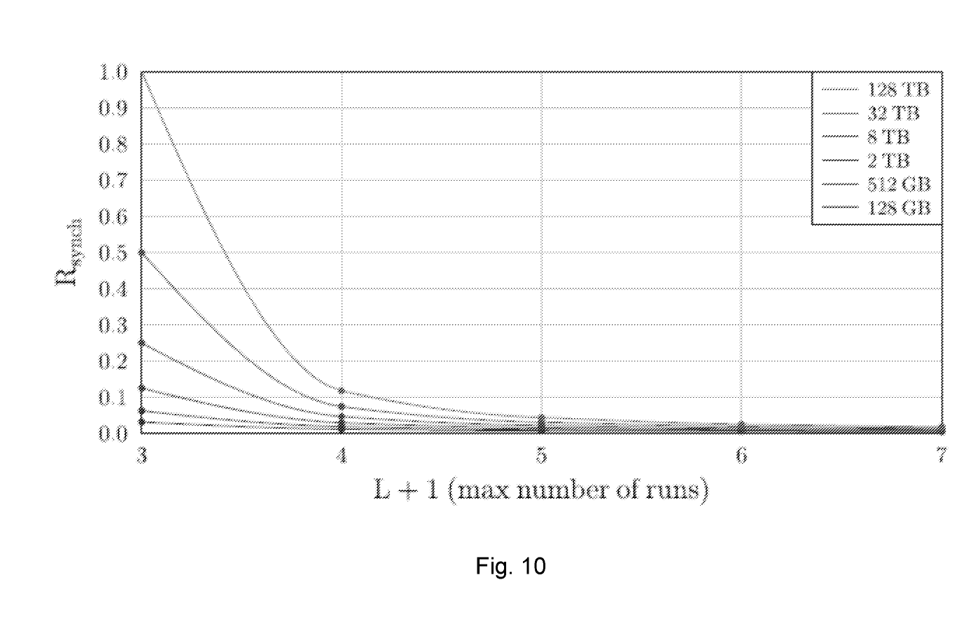

The relationship between T and R_{synch} for LSM-FTL is plotted in FIG. 10 for different flash device capacities. Note that on the x-axis, we use L rather than T. The reason is that L expresses more directly the cost of lookups (there are at most L+1 runs, and so the cost of a lookup is at most L+1 reads). The corresponding value of T for a given value of L is T=Q^{1/L}. The line for the 2 TB device is based on the prototype device from Table 1 in FIG. 2. The other device capacities are gained by increasing or decreasing the number of blocks K of the prototype device.

In FIG. 10, we observe that R_{synch} decreases rapidly as we increase L, and that it ultimately levels off as it approaches 0. For the 2 TB prototype device, tuning L+1 to 4 sets R_{synch} to around 0.05. In some cases, this is a reasonable balance between the cost of lookups and updates.

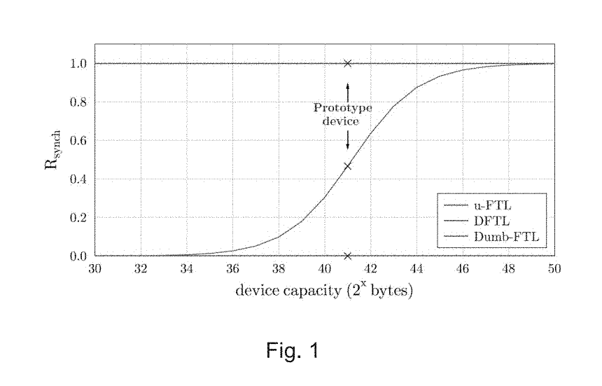

Let us summarise the cost of a data page update or migration in LSM-FTL for the prototype device when L+1=4. As we just saw, there is an amortized cost of 0.05 flash writes and reads per data page update. This cost arises due to the merge operations in the LSM tree. Batch synchronization operations introduce an additional amortized cost of Q/(Q+C) multiplied by the number of runs. We just saw that the number of runs is at most 4, and in FIG. 1 we saw that Q+C is approximately 0.5 for the prototype device. Thus, Q the cost is 2 flash reads. In summary, the approximate cost of a page update or migration in LSM-FTL is on average 0.05 flash writes and 2 flash reads for the 2 TB device.

Let us compare this with DFTL and u-FTL. In DFTL, the cost of a data page or migration is O(Q/(Q+C)) flash reads and writes. For the 2 TB prototype device, this means approximately 0.5 flash reads and writes per data page update or migration. In u-FTL, the cost is 1 flash write and approximately 3 flash reads, since 3 is the predicted depth of u-FTL's B-tree.

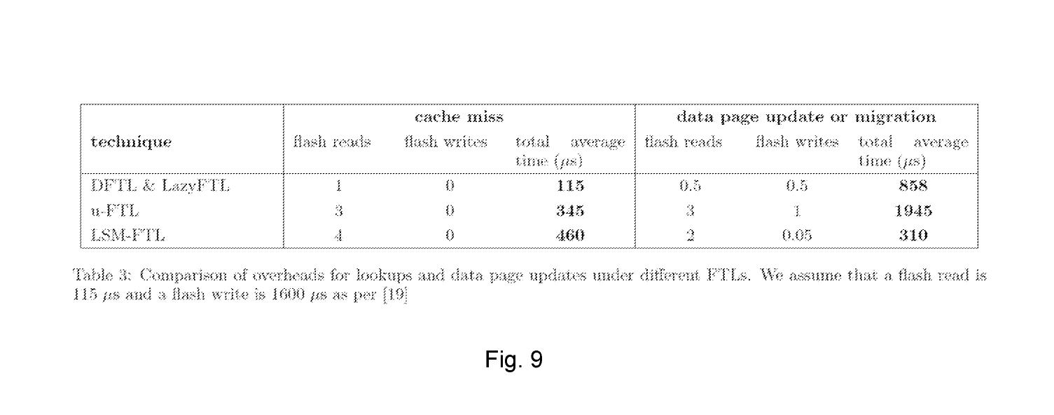

We compare the cost of a page update or migration for the prototype device in Table 3 in FIG. 9, where we also calculate the amount of time of these flash operations based on the figures in [19]. We see that the total average cost of LSM-FTL is 4 times slower than DFTL for cache misses yet more than 2 times faster for data page updates or migrations. This indicates that throughput under write-dominated workloads would be much better under LSM-FTL than under DFTL or u-FTL.

Let us now analyse by how much the reduction in write amplification improves device longevity. Write amplification is approximately equal to the following expression:

WAₜₒₜₐₗ=1+WA_{GC}+WA_{WL}+WA_{MAP}+WA_{PVB}

We know that WA_{PVB} is near 0 since we are using Logarithmic Gecko. As also saw in Section 4 that WA_{MAP}=R_{synch}(1+WA_{GC}+WA_{WL}). By reducing R_{synch} from a worst-case of 1 to a worst case of 0.05, we approximately half write amplification thereby doubling the device lifetime.

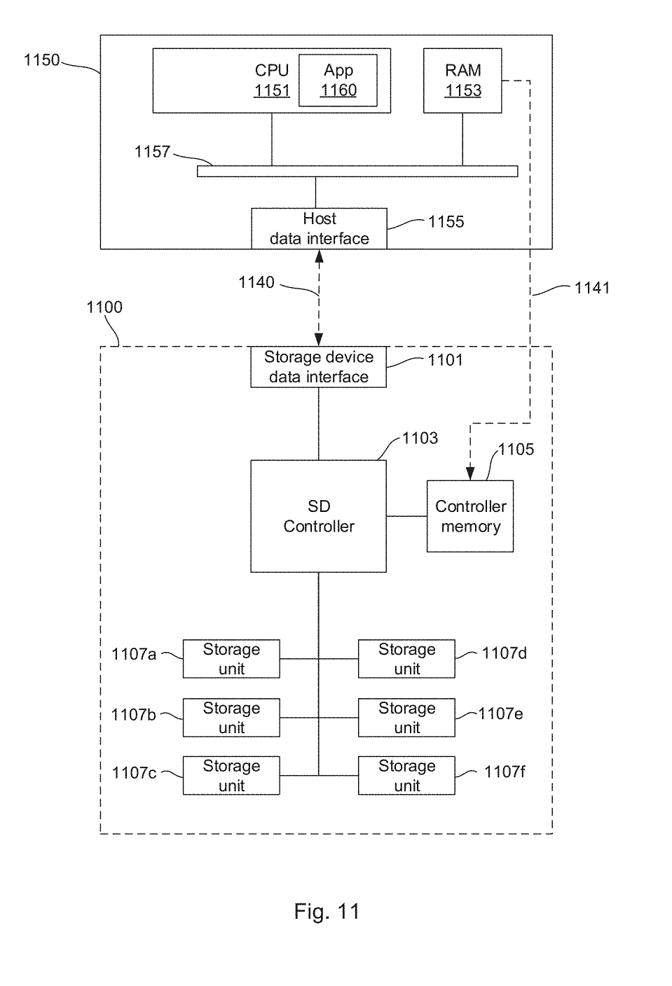

FIG. 11 illustrates a storage device 1100 in accordance with an embodiment of the invention. It comprises a data interface 1101, a storage device (SD) controller 1103, a storage device (SD) controller memory 1105, and a set of storage units 1107a-1107f. The data interface 1101 is used for connecting the storage device 1100 to a host computer, whereby the storage controller 1103 can exchange data with the host. A controller memory 1105 allows the storage controller 1103 to store data temporarily or permanently.

The storage device 1100 in FIG. 11 is configured to connect to a host 1150, such as a personal computer or server computer. The storage device 1100 and host 1150 can be in data communication via a communication line 1140. Simplified, the host 1150 comprises a central processing unit (CPU) 1151, random access memory (RAM) 1153, a host data interface 1155, and a communication bus 1157. The communication bus 1157 enables data communication between the CPU 1151, RAM 1153, and host data interface 1155.

When data is transferred between the host 1150 and the storage device 1100, this may be performed via a direct transfer from the RAM 1153 in the host to the controller memory 1105 in the storage device 1100. Preferably, this takes place without interference of the host CPU 1151 by use of direct memory access (DMA), such as by remote direct memory access (RDMA). This is illustrated schematically with dashed line 1141 in FIG. 11. The physical transfer takes place via the connection 1140 between the host data interface 1155 and the storage device data interface 1101.

The storage device controller is configured to perform one or more of the methods described previously, referred to as algorithms. The algorithms are processes that, when executed on suitable storage device, provide physical transformation in the storage device.

The controller may for instance be configured to update logical pages using the process in FIG. 4. The page's new version is first written onto the active data block. A mapping entry e=(L, P) from the logical page L to its new physical location P is then created and inserted to the cache. This cached entry has an associated dirty flag. It is set to true to indicate that the cached entry should be updated to the LSM tree when it is evicted from cache.

We refer to the detailed description in Section 5 for further details on these processes.

### REFERENCES

[1] N. Agrawal et al. Design tradeo [symbol] s for ssd performance. In USENIX, pages 57-70, 2008.
[2] J. L. Bentley. Decomposable searching problems. Inf. Process. Lett., 8(5):244-251, 1979.
[3] M. Bjørling, P. Bonnet, L. Bouganim, and N. Dayan. The necessary death of the block device interface. In CIDR. www.cidrdb.org, 2013.
[4] L. Bouganim, B. Jonsson, and P. Bonnet. uFlip: Understanding Flash IO Patterns, pages 1-12. CIDR. 2009.
[5] P. Desnoyers. Analytic modeling of ssd write performance. In SYSTOR, pages 12:1-12:10, 2012.
[6] G. Graefe. A survey of b-tree locking techniques. ACM Trans. Database Syst., 35(3):16:1-16:26, July 2010.
[7] L. M. Grupp, J. D. Davis, and S. Swanson. The bleak future of n and flash memory. In Proceedings of the 10th USENIX Conference on File and Storage Technologies, FAST'12, pages 2-2, Berkeley, Calif., USA, 2012. USENIX Association.
[8] A. Gupta, Y. Kim, and B. Urgaonkar. Dftl: A flash translation layer employing demand-based selective caching of page-level address mappings. In ASPLOS, pages 229-240, 2009.
[9] R. Johnson, I. Pandis, N. Hardavellas, A. Ailamaki, and B. Falsafi. Shore-mt: A scalable storage manager for the multicore era. In Proceedings of the 12th International Conference on Extending Database Technology: Advances in Database Technology, EDBT '09, pages 24-35, New York, N.Y., USA, 2009. ACM.
[10] J.-U. Kang, J. Hyun, H. Maeng, and S. Cho. The multi-streamed solid-state drive. In Proceedings of the 6th USENIX Conference on Hot Topics in Storage and File Systems, HotStorage'14, pages 13-13, Berkeley, Calif., USA, 2014. USENIX Association.
[11] J. Kim, J. M. Kim, S. H. Noh, S. L. Min, and Y. Cho. A space-efficient flash translation layer for compactflash systems. IEEE Trans. on Consum. Electron., 48(2):366-375, May 2002.
[12] Y. Kim, B. Tauras, A. Gupta, and B. Urgaonkar. Flashsim: A simulator for n and flash-based solid-state drives. In Proceedings of the 2009 First International Conference on Advances in System Simulation, SIMUL '09, pages 125-131, Washington, D.C., USA, 2009. IEEE Computer Society.
[13] S.-W. Lee, W.-K. Choi, and D.-J. Park. Fast: An efficient flash translation layer for flash memory. In EUC Workshops, pages 879-887, 2006.
[14] Y.-G. Lee, D. Jung, D. Kang, and J.-S. Kim. u-ftl: A memory-efficient flash translation layer supporting multiple mapping granularities. In Proceedings of the 8th ACM International Conference on Embedded Software, EMSOFT '08, pages 21-30, New York, N.Y., USA, 2008. ACM.
[15] D. Ma, J. Feng, and G. Li. Lazyftl: A page-level flash translation layer optimized for nand flash memory. In Proceedings of the 2011 ACM SIGMOD International Conference on Management of Data, SIGMOD '11, pages 1-12, New York, N.Y., USA, 2011. ACM.
[16] D. Ma, J. Feng, and G. Li. A survey of address translation technologies for flash memories. ACM Comput. Surv., 46(3):36:1-36:39, January 2014.
[17] I. Pandis, P. Töz\ddot{}un, R. Johnson, and A. Ailamaki. Pip: Page latch-free shared-everything oltp. Proc. VLDB Endow., 4(10):610-621, July 2011.
[18] C. Park, W. Cheon, J. Kang, K. Roh, W. Cho, and J.-S. Kim. A reconfigurable ftl (flash translation layer) architecture for nand flash-based applications. ACM Trans. Embed. Comput. Syst., 7(4):38:1-38:23, August 2008.
[19] D. Park and D. H. Du. Hot data identification for flash-based storage systems using multiple bloom filters. MSST, pages 1-11, 2011.
[20] R. Stoica and A. Ailamaki. Improving flash write performance by using update frequency. Proc. VLDB Endow., pages 733-744, July 2013.
[21] P. B. Niv Dayan. Garbage collection techniques for flash-resident page-mapping ftls. Arxiv, 2015.
[22] P. B. Niv Dayan, Luc Bouganim. Modelling and managing ssd write-amplification. Arxiv, 2015.
[23] P. O'Neil, E. Cheng, D. Gawlick, and E. O'Neil. The log-structured merge-tree (Ism-tree). Acta Inf., 33(4):351-385, June 1996.
[24] C. Park, W. Cheon, J. Kang, K. Roh, W. Cho, and J.-S. Kim. A reconfigurable ftl (flash translation layer) architecture for nand flash-based applications. ACM Trans. Embed. Comput. Syst., 7(4):38:1-38:23, August 2008.
[25] R. Stoica and A. Ailamaki. Improving flash write performance by using update frequency. Proc. VLDB Endow., pages 733-744, July 2013.
[26] C.-H. Wu and T.-W. Kuo. An adaptive two-level management for the flash translation layer in embedded systems. In Proceedings of the 2006 IEEE/ACM International Conference on Computer-aided Design, ICCAD '06, pages 601-606, New York, N.Y., USA, 2006. ACM.

1. A method for storing a data page d on a solid-state storage device, wherein the solid-state storage device is configured to maintain a mapping table in a Log-Structure Merge (LSM) tree having a C₀ component which is a random access memory (RAM) device and a C₁ component which is a flash-based memory device, the mapping table comprising mapping entries between physical storage pages in the storage device and logical storage page addresses, whereby a physical storage page can be addressed using a corresponding logical storage page address, the method comprising:
writing the data page d at a physical storage page having physical storage page address P in the storage device in response to receiving a write request to store the data page d at a logical storage page having a logical storage page address L,
caching, in a cache in the C₀ component, a new mapping entry e(L,P) associating the logical storage page address L with the physical storage page address P, whereby the data page d can be addressed using the logical storage page address L and using the new mapping entry stored in the C₀ component,
providing an update indication for the cached new mapping entry to indicate that the cached new mapping entry shall be inserted in the C₁ component, and
evicting the new mapping entry from the cache.

2. The method in accordance with claim 1, wherein the evicting comprises:
determining if the update indication for the cached new mapping entry remains provided, and in the affirmative:
i) inserting the new mapping entry into the C₀ component.

3. The method in accordance with claim 2, further comprising:
providing a synchronization indication associated with the new mapping entry, the synchronization indication indicating whether an existing mapping entry in the C₀ component having logical storage page address L, if present in the C₀ component, belongs to a physical storage page that has not been reported to a garbage collection module in the storage device, and in the affirmative reporting said existing mapping entry to the garbage collection module, whereby said existing mapping entry is invalidated.

4. The method in accordance with claim 2, wherein inserting the new mapping entry into the LSM tree C₀ component comprises:
inserting the new mapping entry into an LSM tree buffer comprised in a random access memory unit in the storage device, and at a subsequent time flushing the buffer to the LSM tree C₀ component.

5. The method in accordance with claim 4, further comprising:
determining whether the LSM tree buffer comprises an already buffered mapping entry which is different from the new mapping entry and which has logical storage page address L, and in the affirmative to erase said already buffered mapping entry from the LSM tree buffer.

6. The method in accordance with claim 5, further comprising:
determining whether the LSM tree buffer requires flushing, and in the affirmative to flush the LSM tree buffer to the C₁ component.

7. A solid-state storage device, wherein a digital storage device controller in the solid-state storage device is configured to perform a method in accordance with claim 1.

8. A method for looking up a physical storage page address associated with a logical storage page address L in a solid-state storage device in accordance with claim 7, the method comprising:
determining whether the C₀ component comprises an already cached mapping entry having a logical storage page address L,
and if the C₀ component comprises an already cached mapping entry having logical storage page address L, then:
(1) returning a physical storage page address P of the already cached mapping entry, whereby the lookup has been effectuated,
whereas if the C₀ component does not comprise a cache mapping entry having a logical storage page address L, then:
(a) retrieving an existing mapping entry by performing a search in the LSM tree for an LSM tree mapping entry having logical storage page address L,
(b) inserting the retrieved mapping entry into the cache, and
(c) returning the physical storage page address P of the retrieved mapping entry, whereby the lookup has been effectuated.

9. The method in accordance with claim 8, wherein for the case when the C₀ component does not comprise a cache mapping entry having a logical storage page address L, the method further comprises:
(i) providing an update indication for the retrieved mapping entry to indicate that the retrieved mapping entry shall not be inserted in the LSM tree C₁ component at a subsequent time, and
(ii) providing an indication that the retrieved mapping entry belongs to a valid storage page.

10. The method in accordance with claim 9, further comprising:
determining if the cache is full, and in the affirmative evicting another mapping entry from the cache, said another mapping entry being different from the retrieved mapping entry.

11. The method in accordance with claim 10, further comprising:
determining whether a synchronization indication associated with said another mapping entry indicates that an existing mapping entry in the LSM tree C₀ component has logical storage page address L and belongs to a storage page that has not been reported to a garbage collection module in the storage device, and in the affirmative reporting said existing mapping entry to the garbage collection module, whereby said existing mapping entry is invalidated, and
determining if the update indication for said another mapping entry remains provided, and in the affirmative:
i) inserting said another mapping entry into the LSM tree C₀ component.

12. The method in accordance with claim 11, wherein inserting said another mapping entry into the LSM tree C₀ component comprises:
inserting said another mapping entry into an LSM tree buffer, and subsequently flushing the buffer to the LSM tree C₀ component.

13. The method in accordance with claim 12, further comprising:
determining if the LSM tree buffer comprises an already buffered mapping entry different from said another mapping entry and having logical storage page address L, and in the affirmative to erase said already buffered mapping entry from the buffer.

14. The method in accordance with claim 13, further comprising:
determining whether the LSM tree buffer is full, and in the affirmative flush the buffer to the C₁ component.

15. A solid-state storage device, wherein a digital storage device controller in the solid-state storage device is configured to perform a method in accordance with claim 8.
